(19) United States
(12) Patent Application Publication
(10) Pub. No.: US 2012/0090625 A1
(43) Pub. Date: Apr. 19, 2012

(54) MOUTH GUARD

(75) Inventors: Jeffrey M. Evans, Omaha, NE (US); Christopher W. Circo, Omaha, NE (US)

(73) Assignee: C&E SPORTS, L.L.C., Omaha, NE (US)

(21) Appl. No.: 12/907,738

(22) Filed: Oct. 19, 2010

(51) Int. Cl. A61C 5/14

(52) U.S. Cl. 128/861

(57) ABSTRACT

A mouth guard comprising an arcuate body member positionable between the teeth of a user. The body member includes an incisor portion for confronting the incisors of the user and a pair of molar portions for confronting the molars of the user. Each said molar portion includes a hollow region. The hollow region may extend through its respective molar portion. Alternatively, the hollow region is contained within the body member and may also be air tight. The hollow region could also be a blind cavity. A resilient member, such as a spring or foam material, may be disposed within the hollow region. A bladder may be disposed in the hollow region, such as an air bladder or a bladder containing gel. A resilient member, such as a spring or foam material, may be disposed within the bladder. The bladder may be formed of a translucent or transparent material.

### BACKGROUND

Concussion, or mild traumatic brain injury (MTBI), is the most common type of traumatic brain injury. Sports-related concussions have increased over the years. This may be relative to the increased physical stature of athletes and the intensity of contact sports over time. Frequently defined as a head injury with a temporary loss of brain function, concussion can cause a variety of physical, cognitive, and emotional symptoms.

The human body generally is built to protect the brain from traumatic injury. Cerebrospinal fluid surrounds the brain beneath the skull. The skull provides the hardened exterior protection, while the cerebrospinal fluid provides a hydraulic “cushion” that protects the brain from light trauma. However, severe impacts or forces associated with rapid acceleration and deceleration may not be absorbed by this cushion. As they are understood, however, concussions are likely caused by impact forces, in which the head strikes or is struck by an object. In other instances, concussion may be caused by impulsive forces, in which the head moves without itself being subject to blunt trauma, such as in the case of severe whiplash.

Concussive forces may engage an individual's head in a manner that causes linear, rotational, or angular movement of the brain. In rotational movement, the head turns around its center of gravity, and in angular movement it turns on an axis not through its center of gravity. Concussions and their proximate causation remain the center of study and debate. However, it is generally accepted that the threshold amount of blunt force for concussion is approximately 70-75 g. Impacts to the individual's head of this magnitude and greater are thought to adversely affect the midbrain and diencephalon. The forces from the injury are believed to disrupt the normal cellular activities in the reticular activating system located in these areas. Such disruption may produce loss of consciousness, which often occurs in concussion injuries.

The prior art has produced a wide array of protective equipment, such as helmets, mouth guards, and other headgear in an attempt to reduce the number of sports-related concussions. In particular, mouth guards are believed to help prevent concussions as well as protect the user's teeth from damage. Traditionally, mouth guards have been formed of plastic or rubber and engage a user's upper teeth to keep the guard in position. Some mouth guards include moldable materials whereby a user can custom fit the mouth guard to their teeth for a more comfortable fit. In the past, a mouth guard that kept the user's teeth from contacting each other was considered sufficient. Regarding concussions, traditional mouth guards have generally relied on the resiliency of the plastic or rubber that they are formed from to cushion an impact transferred through a user's jaw. Thus, there exists a need to innovate to innovate with respect to mouth guard design in order to better help prevent concussion injuries.

### SUMMARY

This Summary is provided to introduce a selection of concepts in a simplified form that are further described below in the Detailed Description. This Summary, and the foregoing Background, are not intended to identify key aspects or essential aspects of the claimed subject matter. Moreover, this Summary is not intended for use as an aid in determining the scope of the claimed subject matter.

Described herein is a mouth guard that comprises an arcuate body member positionable between the upper and lower teeth of a user for protecting the user's teeth and helping to prevent concussions. The body member includes an incisor portion for confronting the incisors of the user and a pair of molar portions for confronting the molars of the user. Each said molar portion includes a hollow region. The hollow region may extend through its respective molar portion. Alternatively, the hollow region is contained within the body member and may also be air tight. The hollow region could also be a blind cavity. A resilient member, such as a spring or foam material, may be disposed within the hollow region.

A bladder may be disposed in the hollow region, such as an air bladder or a bladder containing gel. A resilient member, such as a spring or foam material, may be disposed within the bladder. The bladder may be formed of a translucent or transparent material.

The mouth guard may also be described as including an arcuate body member positionable between the maxilla and mandible of a user. The mouth guard includes a pair of walls extending from the body member to form a tray adapted to receive the maxillary teeth of the user. The tray includes an incisor region and a pair of molar regions. At least one hollow region is formed in the body member below the tray. The hollow region may be formed below the incisor region, below the molar regions or both.

These and other aspects of the mouth guard will be apparent after consideration of the Detailed Description and Figures herein. It is to be understood, however, that the scope of the invention shall be determined by the claims as. issued and not by whether the given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 is a perspective view of a mouth guard according to a first exemplary embodiment as viewed from the front and top;

FIG. 2 is a perspective view of the mouth guard shown in FIG. 1 as viewed from the rear and bottom;

FIG. 3 is a top plan view of the mouth guard shown in FIGS. 1 and 2;

FIG. 4 is a side view in elevation of the mouth guard shown in FIGS. 1-3;

FIG. 5 is a bottom plan view of the mouth guard shown in FIGS. 1-4;

FIG. 6 is a front view in elevation of the mouth guard shown in FIGS. 1-5;

FIG. 7 is a rear view in elevation of the mouth guard shown in FIGS. 1-6;

FIG. 8 is a side view in elevation of a mouth guard according to a second exemplary embodiment;

FIG. 9 is a side view in elevation of a mouth guard according to a third exemplary embodiment;

FIG. 10 is a side view in elevation of a mouth guard according to a fourth exemplary embodiment; and

FIG. 11 is a side view in elevation of a mouth guard according to a fifth exemplary embodiment.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

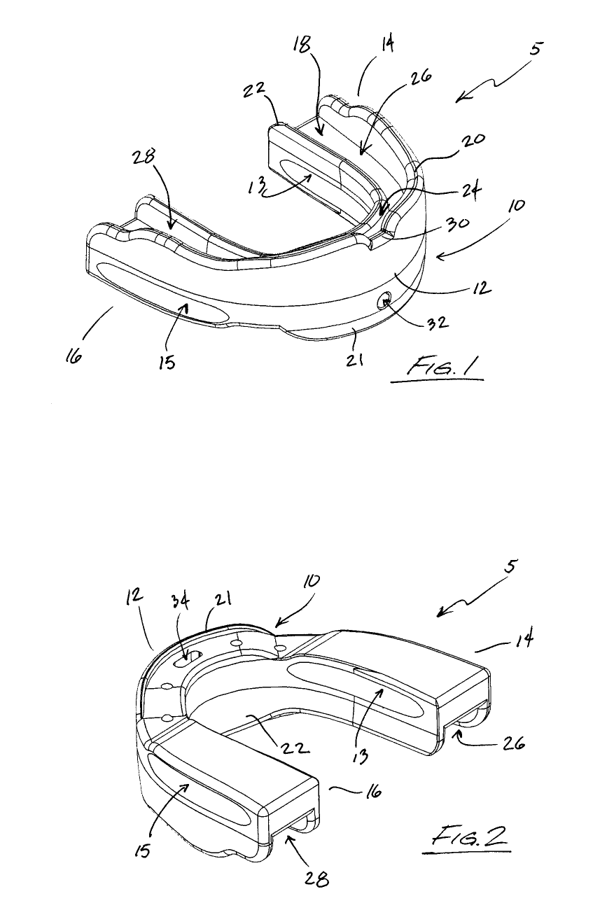

As shown in FIG. 1, mouth guard 5 according to a first exemplary embodiment includes an arcuate body member 10 positionable between a user's upper (maxillary) and lower (mandibular) teeth. Body member 10 includes an incisor portion 12 for confronting the incisors of the user and molar portions 14 and 16 for confronting the molars of the user. In this embodiment, each molar portion 14 and 16 includes a hollow region 13 and 15, respectively, formed therein. The hollow regions 13 and 15 may be formed as an air tight cavity or bubble within the molar regions or as an open cavity. An open cavity may be in the form of a blind cavity or a cavity that is formed completely through the molar regions as shown in FIG. 1. It should be appreciated that while the hollow regions 13 and 15 are shown in the molar regions 14 and 16 in this case, hollow regions may be included in the incisor portion 12 in addition to or instead of the molar portions.

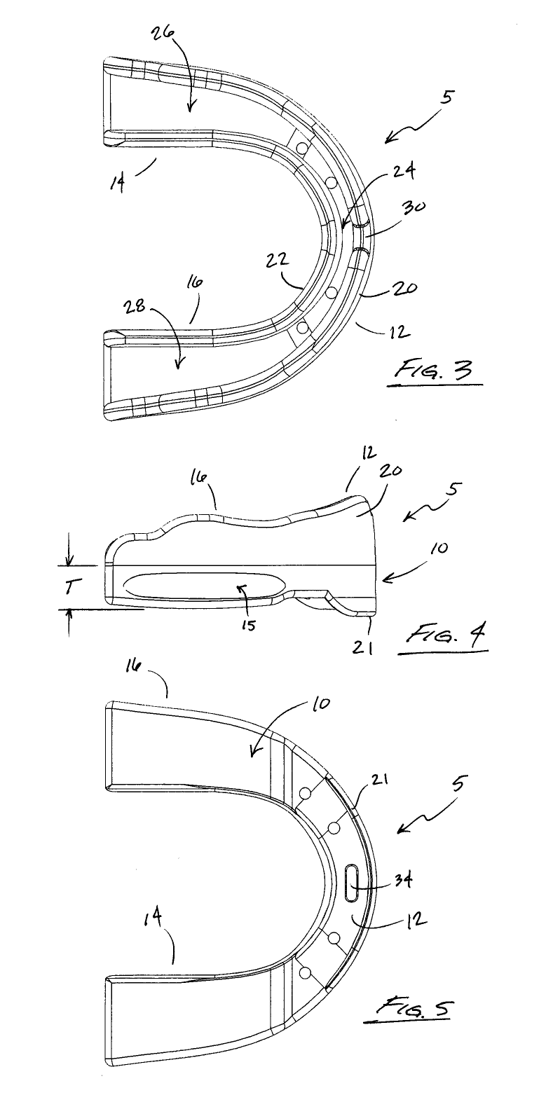

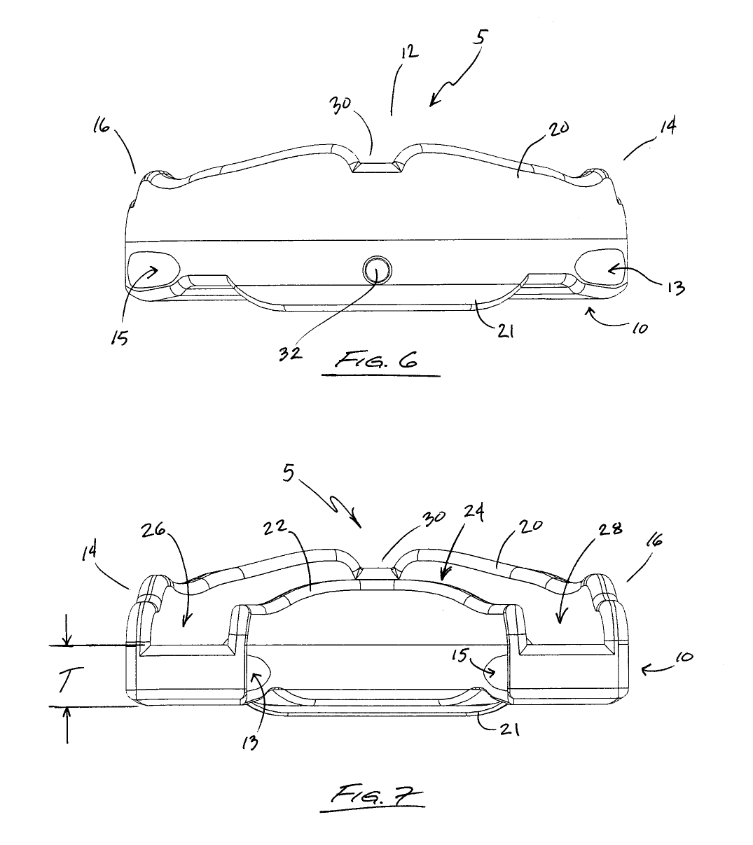

With further reference to FIGS. 2-7, mouth guard 5 also includes a pair of walls 20 and 22 extending from body member 10 along the peripheries of the body member 10 to form a tray 18 that is adapted to receive the upper teeth of the user. The tray includes an incisor region 24 and a pair of molar regions 26 and 28. Wall 20 may also include a notch 30 to provide clearance for the user's upper lip frenulum. Mouth guard 5 may also include a lower wall 21 extending from body member 10 at least partially along incisor portion 12.

As best shown in FIGS. 1 and 2, mouth guard 5 includes an aperture 32 extending into the body member 10 proximate the incisor portion 12. As shown in FIG. 2, another aperture 34 extends into body member 10 transversely with respect to aperture 32. Apertures 32 and 34 intersect in order to provide an attachment for a securing strap (not shown) if desired.

Hollow regions 13 and 15 provide a cushion against impact which helps prevent head injuries such as concussions. With specific reference to FIGS. 4 and 7, it can be appreciated that body member 10 has a thickness T. Thickness T is selected such that the user's jaw is held at a partially open position, thereby separating the user's teeth in order to protect the teeth from damage due to contact therebetween. Also, by holding the user's jaw in a partially open position the user's temporomandibular joints (TMJ) fill with natural fluids which act to further cushion an impact.

FIG. 8 illustrates a mouth guard 105 according to a second exemplary embodiment that includes a closed hollow region 113 that is completely contained within the body member. In this embodiment the hollow region is airtight. Accordingly, hollow region 113 includes an air pocket which provides an air cushioning effect in the event of an impact. Hollow region 113 may also contain, for example and without limitation, foam, liquid, gel, gas, other material. The hollow regions may be filled with a different material which has different properties, such as durometer, porosity, and the like.

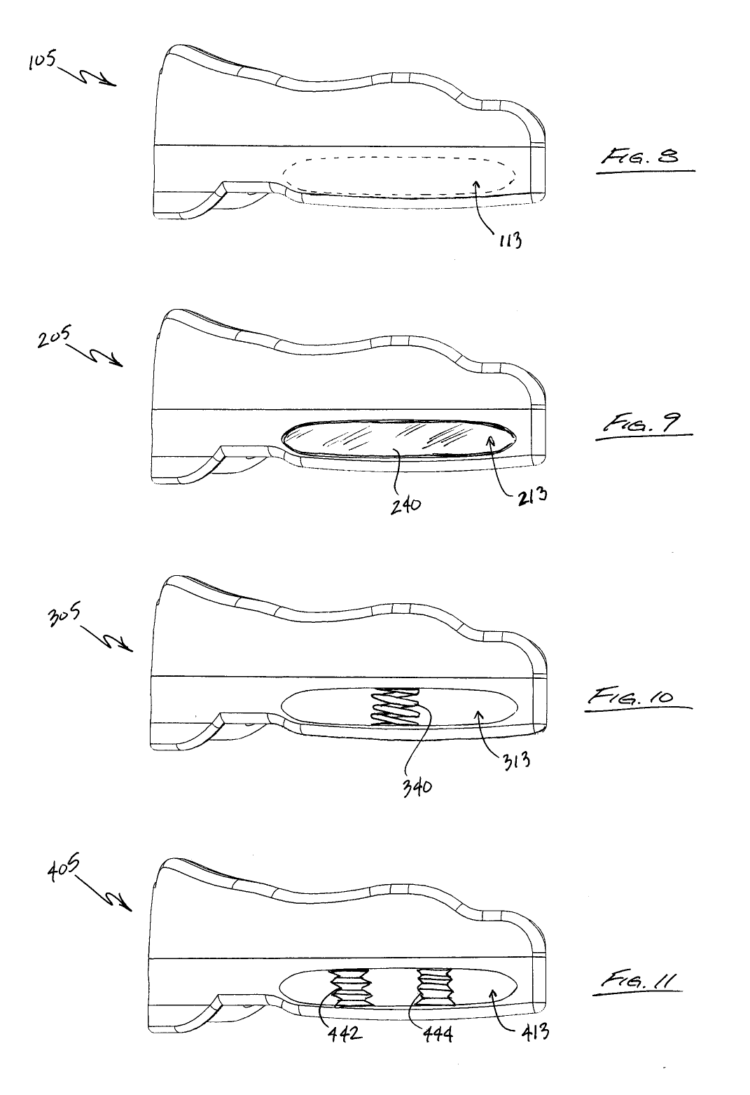

FIG. 9 illustrates a mouth guard 205 according to a third exemplary embodiment that includes a bladder 240 disposed in the hollow region 213. Bladder 240, in this instance, is an airtight bladder which may contain for example and without limitation, foam, liquid, gel, gas, other material. Bladder 240 may be comprised of a translucent or transparent material in order to display the contents therein.

FIG. 10 illustrates a mouth guard 305 according to a fourth exemplary embodiment that includes a resilient member in the form of a spring 340 which is disposed in a open hollow region 313. Spring 340 may be comprised of metal such as a traditional spring or comprised of a suitable plastic material. Although shown in this embodiment with a single spring 340, mouth guard 305 could include multiple springs.

FIG. 11 illustrates mouth guard 405 according to a fifth exemplary embodiment that includes a pair of resilient members 442 and 444 in the form of foam cushions or springs. Although a pair of foam springs is shown in this embodiment a larger or smaller number of resilient members may be included in the hollow region 413.

It is also contemplated that a bladder, such as bladder 241 shown in FIG. 9, could contain a resilient member therein in order to provide additional resiliency and impact cushioning. The bladder could contain any one of or a combination of the resilient members described above, for example, depending on the application.

The mouth guards described herein may be formed of a suitable rubber or plastic materials as are known in the art. For example and without limitation, the mouth guard may be formed from thermoplastic elastomer (TPE) or ethylene vinyl acetate (EVA) or a combination thereof. The mouth guard may be formed by any suitable manufacturing process, such as for example injection molding, insert molding, welding, gluing, and the like. In addition, the mouth guards described herein may be decorated with in mold labeling and in mold decorating techniques as are known in the art.

Although the technology and methods of using and/or applying the same have been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A mouth guard, comprising:
an arcuate body member positionable between upper and lower teeth of a user, said body member including:
an incisor portion for confronting the incisors of the user; and
a pair of molar portions for confronting the molars of the user, each said molar portion including a hollow region formed therein.

2. The mouth guard according to claim 1, wherein each said hollow region extends through its respective molar portion.

3. The mouth guard according to claim 1, wherein each said hollow region is air tight.

4. The mouth guard according to claim 1, including a bladder disposed in each said hollow region.

5. The mouth guard according to claim 4, wherein said bladder is an air bladder.

6. The mouth guard according to claim 4, including a resilient member disposed in said bladder.

7. The mouth guard according to claim 4, wherein said bladder is comprised of a translucent material.

8. The mouth guard according to claim 1, including a resilient member disposed in said hollow region.

9. The mouth guard according to claim 8, wherein said resilient member is a spring.

10. The mouth guard according to claim 8, wherein said resilient member is foam.

11. A mouth guard, comprising:
an arcuate body member positionable between a maxilla and mandible of a user;
a pair of walls extending from said body member to form a tray adapted to receive the maxillary teeth of the user, said tray including an incisor region and a pair of molar regions; and
at least one hollow region formed in said body member.

12. The mouth guard according to claim 11, wherein said at least one hollow region is formed below said incisor region.

13. The mouth guard according to claim 11, including a hollow region formed below each said molar region.

14. The mouth guard according to claim 11, wherein each said hollow region extends through said body member.

15. The mouth guard according to claim 11, including a bladder disposed in said hollow region.

16. The mouth guard according to claim 15, wherein said bladder is an air bladder.

17. The mouth guard according to claim 15, including a resilient member disposed in said bladder.

18. The mouth guard according to claim 11, including a resilient member disposed in said hollow region.

19. A mouth guard, comprising:
an arcuate body member positionable between the maxilla and mandible of a user;
a pair of walls extending from said body member to form a tray adapted to receive the maxillary teeth of the user, said tray including an incisor region and a pair of molar regions;
a hollow region formed through said body member below each one of said pair of molar regions; and
a bladder disposed in each said hollow region.

20. The mouth guard according to claim 18, including a resilient member disposed in said bladder.
